(19) United States
(12) Patent Application Publication
(10) Pub. No.: US 2014/0115539 A1
(43) Pub. Date: Apr. 24, 2014

(54) CUSTOMIZED SHORTCUTS FOR RESOURCE BROWSING METHOD AND APPARATUS

(71) Applicant: YAHOO! INC., Sunnyvale, CA (US)

(72) Inventors: Ting-Liang Chou, New Taipei City (TW); Shih-Ying Chen, New Taipei City (TW); Hsuan-Hao Chan, Taipei City (TW)

(73) Assignee: YAHOO! INC., Sunnyvale, CA (US)

(21) Appl. No.: 13/654,812

(22) Filed: Oct. 18, 2012

(51) Int. Cl. G06F 3/0481

(52) U.S. Cl. CPC G06F 3/04817
USPC 715/835

(57) ABSTRACT

A shortcut graphical user interface (GUI) comprising user-selectable icons, each representing a shortcut and corresponding to and providing access to a resource, e.g., a web resource. When triggered, the shortcut GUI may be rendered in an application window, e.g., superimposed on the contents displayed in the application window. The shortcut GUI may be rendered at a location in the application window specified by the user and/or a pre-stored location. The application may be a browser application that allows the user to access web resources, and each shortcut icon in the shortcut GUI may represent a uniform resource locator (URL) identifying a web resource accessible upon user selection of the shortcut icon.

### FIELD OF THE DISCLOSURE

The present disclosure generally relates to providing resource browsing shortcuts, and more particularly to providing customized shortcuts for use in browsing resources, such as web pages and shortcuts for use in switching between pages of a website or websites.

### BACKGROUND

Typically, a user uses an application such as a browser application to access a resource, e.g., a web resource. For example, a user might user a browser application to view a web page received at the user's computing device; the web page typically originates from a website server and is transmitted over the internet and/or other network to the user's computing device. The browser application, or browser, typically displays the web page in window on a display connected to the user's computing device. Where the web page is too large to fit in the entire page in the window, the user is able to view other portions of the web page using user interface controls, such as scroll up, scroll down, scroll right, scroll left, etc.

A website may act as a web portal, or portal, that provides multiple sites, properties, services, web applications, etc., such as without limitation electronic mail and/or messaging, financial information, searching, entertainment, etc. The user may navigate to a web portal's main, or home page, as an entry point; the web portal typically has the main, or home, page, via which the user may gain access to other sites, etc., via hyperlinks, or a links, selectable by the user.

### SUMMARY

In order to access a resource using a hyperlink, or link corresponding to a universal resource locator (URL), the user must first navigate to the link, which may not be readily accessible, e.g., the link is not visible in the application window. The user might have to navigate to another portion of the data output by the application, e.g., a portion that is not currently being displayed by the application, e.g., by scrolling to the portion of the application display data containing the link, e.g., navigate to another portion of a web page and/or navigate to another web page altogether. By way of one example, a web portal may provide a news site or service and a financial information site, such that the web portal's main page has a link to the new service's main web page and the link to the financial information service's main page. While viewing a news article via the news service, the user might wish to access the financial information service to retrieve information about a company discussed in the news article provided by the new service. To access the financial information service, the user must type in the universal resource locator (URL) or locate a link located somewhere on the web page currently being displayed by the web browser. In one scenario used for purposes of illustration, where the link to the financial information server is located on another web page, e.g., the web portal's main page, the user must navigate back to the other web page and click on the link to access the financial information service. This scenario places a burden on computing and network resources to load the other page containing the link, and burdens the user as well. In another illustrative scenario, where the link is located on the current web page, the user must search the web page, which may involve the user scrolling to view another portion of the web page to locate the link before selecting the link. In this scenario, the user is required to search for the link on the current page, and at least a portion of the web page must be used to display the link, which portion is not for displaying other content, e.g., primary content of the web page, such as contents of the news article.

It would be beneficial to make a link, or other selection mechanism, to a web resource, such as web page, readily available to the user, such as by providing a graphical user interface (GUI) at a point within an application display window to provide indicia, e.g., icons, that are selectable by the user to access resources. The shortcut GUI display may be superimposed on, or overlaid over, the existing application display data already being displayed in the application window. The shortcut GUI may be displayed in response to user input requesting that the shortcut GUI be displayed. The display location of the shortcut GUI may be specified by the user.

In accordance with at least one aspect of the present disclosure, a shortcut GUI may be displayed in response to user input, which GUI comprises one or more selectable indicia, each indicium corresponding to a link. Each selectable indicium may be represented by an icon in the GUI. The GUI may be displayed within a current-displayed application window, e.g., web browser window, on a display for the user at position within the application window that may be designated by the user. Once displayed, the shortcut GUI may be used by the user to select one of the icons, thereby selecting the corresponding link, to access a corresponding web resource, e.g., a web page, media content, etc., associated with the link. In the illustrative example provided above, the user is able to select a shortcut to a web page for the financial information service from a location, e.g., a user-designated location, within the news service's web page. Advantageously, the user is able to access the financial information service without first returning to the web portal's main page and/or searching for a link to the financial information service's web page within the news service's web page. Additionally, it would be beneficial to customize some or all of the shortcuts for a given user.

A web portal is used herein as one scenario in which the shortcut GUI might be used; however, the shortcut GUI might be used on any website or web page. Additionally, a web page is used herein as an example of a resource that may represented by a shortcut displayed in the shortcut GUI; however, embodiments of the present disclosure may be used to provide a shortcut to any type of resource, including without limitation media content, such as without limitation streaming audio and/or video content, images, photographs, etc.

In accordance with one or more embodiments, a method is provided, which method comprises receiving a triggering event by at least one computing device, the event having location information identifying a display location; retrieving, by the at least one computing device in response to the triggering event, shortcut information comprising a set of shortcut mappings, each shortcut mapping associating a selectable indicium in a shortcut graphical user interface (GUI) and a resource identifier; causing, by the at least one computing device, the shortcut GUI to be displayed superimposed on an application display window for the user at the display location; and in response to receiving input indicative of the user selection of the selectable indicium in the shortcut GUI, the at least one computing device accessing the resource for the user using the resource identifier.

In accordance with one or more embodiments, a system is provided, which system comprises at least one computing device, each device comprising one or more processors to execute and memory to store instructions, to receive a triggering event, the event having location information identifying a display location; retrieve, in response to the triggering event, shortcut information comprising a set of shortcut mappings, each shortcut mapping associating a selectable indicium in a shortcut graphical user interface (GUI) and a resource identifier; cause the shortcut GUI to be displayed superimposed on an application display window for the user at the display location; and in response to receiving input indicative of the user selection of the selectable indicium in the shortcut GUI, access the resource for the user using the resource identifier.

In accordance with one or more embodiments, a computer readable non-transitory storage medium is provided for tangibly storing thereon computer readable instructions that when executed cause at least one processor to receive a triggering event, the event having location information identifying a display location; retrieve, in response to the triggering event, shortcut information comprising a set of shortcut mappings, each shortcut mapping associating a selectable indicium in a shortcut graphical user interface (GUI) and a resource identifier; cause the shortcut GUI to be displayed superimposed on an application display window for the user at the display location; and in response to receiving input indicative of the user selection of the selectable indicium in the shortcut GUI, access the resource for the user using the resource identifier.

In accordance with one or more embodiments, a system is provided that comprises one or more computing devices configured to provide functionality in accordance with such embodiments. In accordance with one or more embodiments, functionality is embodied in steps of a method performed by at least one computing device. In accordance with one or more embodiments, program code to implement functionality in accordance with one or more such embodiments is embodied in, by and/or on a computer-readable medium.

### DRAWINGS

The above-mentioned features and objects of the present disclosure will become more apparent with reference to the following description taken in conjunction with the accompanying drawings wherein like reference numerals denote like elements and in which:

FIG. 1, which comprises FIGS. 1A, 1B and 1C, provides an overview of a process flow implemented by a shortcut program or system tier use in accordance with one or more embodiments of the present disclosure.

FIG. 2 provides pseudocode examples of a shortcut program in accordance with one or more embodiments of the present disclosure.

FIG. 3 provides an example of a shortcut GUI in accordance with one or more embodiments of the present disclosure.

FIGS. 4 and 5 provide examples of a shortcut GUI rendered in an application window.

FIG. 6 illustrates some components that can be used in connection with one or more embodiments of the present disclosure.

FIG. 7 is a detailed block diagram illustrating an internal architecture of a computing device in accordance with one or more embodiments of the present disclosure.

### DETAILED DESCRIPTION

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The detailed description provided herein is not intended as an extensive or detailed discussion of known concepts, and as such, details that are known generally to those of ordinary skill in the relevant art may have been omitted or may be handled in summary fashion.

In general, the present disclosure includes customized shortcuts for web browsing system, method and architecture.

Certain embodiments of the present disclosure will now be discussed with reference to the aforementioned figures, wherein like reference numerals refer to like components.

One or more embodiments provide a shortcut GUI, which GUI comprises user-selectable icons, each user-selectable icon representing a shortcut and corresponding to providing access to a resource, e.g., a web resource. When triggered, the shortcut GUI may be rendered in an application window, e.g., superimposed on the contents displayed in the application window. The shortcut GUI may be rendered at a location in the application window specified by the user and/or a pre-stored location. The application may be a browser application that allows the user to access web resources, and each shortcut icon in the shortcut GUI may represent a uniform resource locator (URL) identifying a web resource accessible upon user selection of the shortcut icon.

In accordance with one or more embodiments, shortcut functionality may be implemented by a software program encoded using a scripting language, such as JavaScript, which program may be executed in connection with an application, such as a browser application, executing on a user's computing device. The shortcut functionality may be activated by a triggering event, such as one or more mouse click events within a display window of an application. A triggering event might comprises a single-click or a double-click mouse button, e.g., left mouse button, input detected at the user's computing device, e.g., single or double mouse click(s) event detected within a browser application's window.

While embodiments are described with reference to mouse click input, it should be apparent that other input devices, such as a keyboard, touch screen etc., may be used in addition to or instead of a mouse, or other pointing device. A user may indicate a desire for display of the shortcut GUI using any input mechanism, including without limitation a mouse or other pointing device, touch tablet/screen, keyboard, etc. By way of a further non-limiting example, a user might use cursor keys to identify a location for the shortcut GUI and input a key or keys to indicate a desire to activate or deactivate display of the shortcut GUI.

By way of a non-limiting example, a double-click mouse event detected within an application window may trigger display of a shortcut GUI, or shortcut widget GUI; and, in response, the shortcut GUI might be displayed within the display window over the contents of window, e.g., overlaid on or superimposed on the contents being displayed at the time that the user indicated the desire to have the shortcut GUI displayed.

In accordance with one or more embodiments, the shortcut program may be loaded on the client's computing device and may listen for a triggering event, or events. While embodiments are described using examples of a shortcut program executing on a user's computing device, it should be apparent that some or all of the shortcut program's functionality may be performed by another computing device, including without limitation one or more server computers, or computing devices.

Where a triggering event is detected by the shortcut program, the program causes the shortcut widget GUI to be rendered, or displayed. By way of a non-limiting example, the shortcut program may instruct the display driver at the user's computing device to display the shortcut GUI. By way of another non-limiting example, the shortcut program may instruct the application program, e.g., the application program having the application window in which the triggering event is detected, to display the shortcut GUI.

In accordance with one or more embodiments, as discussed above, the shortcut GUI might be displayed superimposed, overlaid on or above, the contents of the window displayed at the time of the triggering event, e.g., which contents may be some or all of a webpage displayed by a browser application. In accordance with one or more embodiments, the shortcut GUI comprises a plurality of icons, some of which may correspond to hyperlinks, or links, to web resources, such as webpages. The shortcut GUI may comprise other icons selectable by the user to configure shortcuts and/or the shortcut GUI.

The user may click on one of the icons mapped to a resource, e.g., a web resource, to navigate to the resource associated with the icon. The shortcut program may listen for a deactivation event, such as a mouse event, e.g., single-click or double-click mouse input received from the user. Where a deactivation event is detected, the shortcut program may instruct the application program and/or the computing device's system software, e.g., display driver, to remove the shortcut GUI from the device's display.

In accordance with one or more embodiments, the user is able to indicate a desire to display a shortcut GUI, a location at which the shortcut GUI is to be displayed, and indicate a desire to remove the shortcut GUI from the display using an input device, or devices. In addition and in accordance with one or more embodiments, the user is able to customize the shortcut GUI, e.g., specify one or more shortcuts for inclusion in, or exclusion from, the shortcut GUI. In accordance with one or more embodiments, the location at which the shortcut GUI is displayed may be determined using pre-stored location information, which information may be specified by the user.

In accordance with one or more embodiments, the shortcut GUI may initially include a default set of icons, which the user may modify or customize. A default configuration may comprise a set of shortcuts specifically selected for the user and/or a set of shortcuts selected for a general audience. The default configuration may include one or more shortcuts selected based on a user community as a whole, based on a group of users to which the user is determined to belong, e.g., based on a determined affinity, and/or selected based on information known about the user, e.g., information gleaned from web browsing history, user preferences, etc. It should be apparent that any recommendation method now known or later developed may be used in determining a set of shortcuts for a user or users. In accordance with one or more embodiments, the user is provided with an ability to modify the GUI, e.g. edit/modify, delete and/or add shortcuts, reorder shortcuts, etc. In response to receiving the triggering event indicating a user's desire to activate the shortcut GUI, a set of shortcuts, e.g., default or customized, may be retrieved for the user. As discussed herein, the set of shortcuts may be part of shortcut data that is stored at the user's computing device and/or stored by one or more server computers. The shortcut GUI that is displayed for the user includes a set of icons, each icon of which corresponds to a shortcut in the set of shortcuts, and each icon is selectable by the user to access an associated resource.

In accordance with one or more embodiments, in addition to the set of icons that provide shortcuts to resources, the shortcut GUI may include one or more icons that may be used by the user to reconfigure the shortcut GUI, e.g. edit/modify, delete and/or add shortcuts, reorder shortcuts, etc.

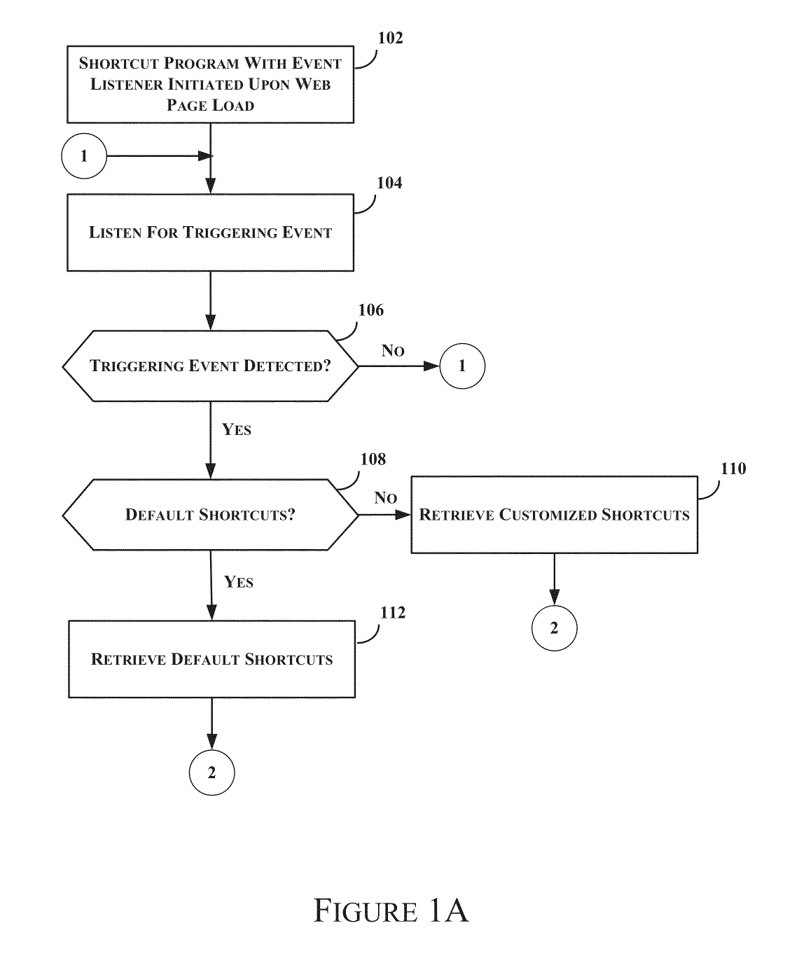

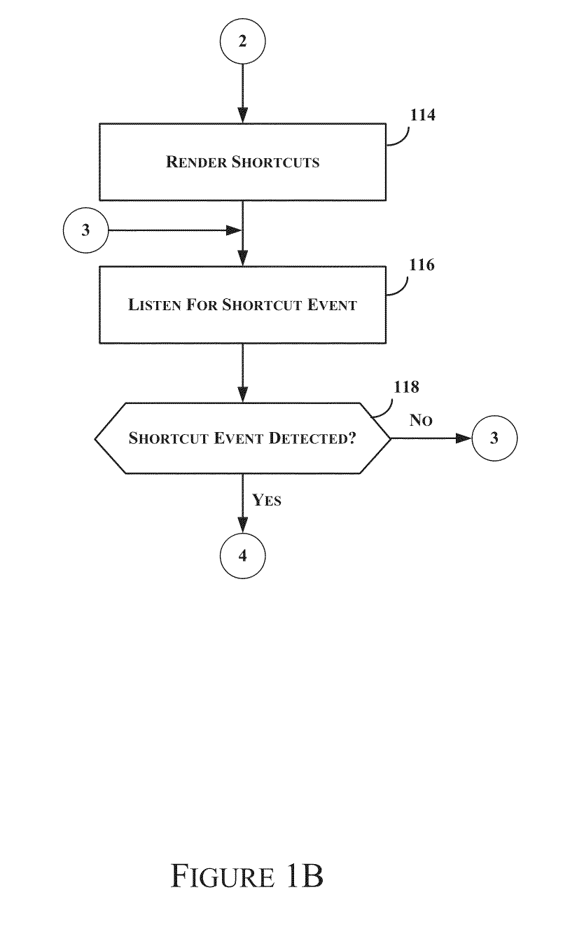

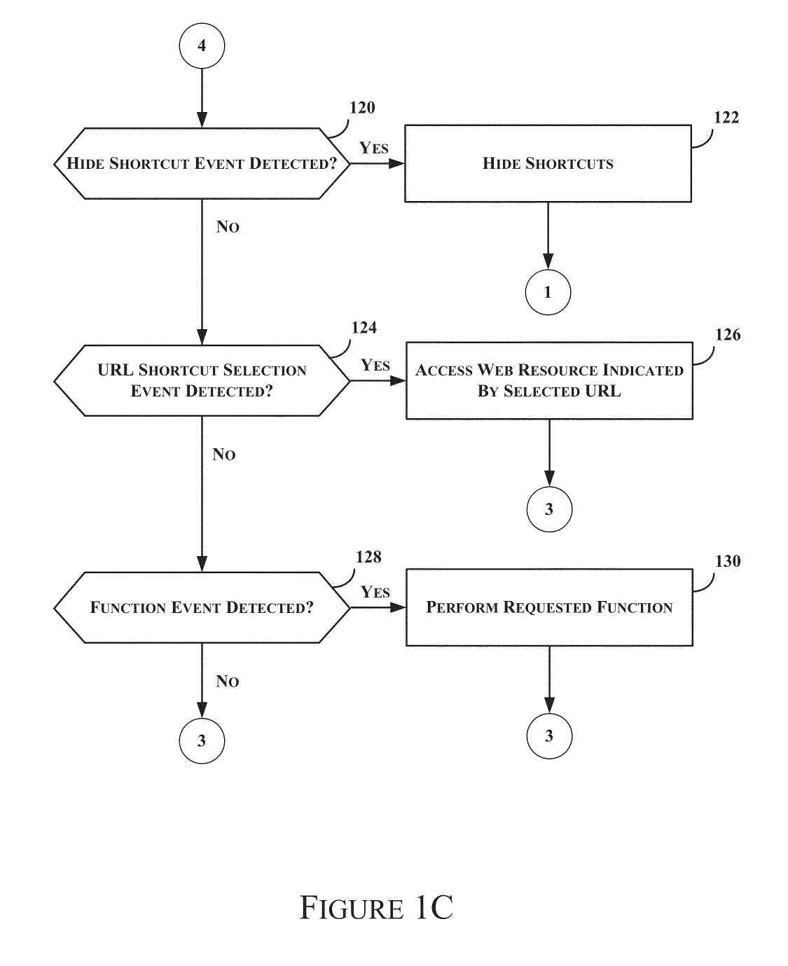

FIG. 1, which comprises FIGS. 1A, 1B and 1C, provides an overview of a process flow implemented by a shortcut program or system for use in accordance with one or more embodiments of the present disclosure. In accordance with one or more embodiments, the shortcut program, or system, may reside on the user's computing device. Alternatively, the shortcut program, or system, may be resident on another computing device, such as a server computer, which executes the program/system. As yet another alternative, the functionality provided by the shortcut program/system may be spread across multiple computers, e.g., a user's computing device and one or more server computers.

In the example shown in FIG. 1, as illustrated at step 102, the shortcut program may be downloaded in connection with loading a webpage by a browser application, e.g., the browser application may obtain the shortcut program, e.g., JavaScript program, by requesting a download from a server computer to the user's computing device, by retrieving the program from memory or other storage coupled to the user's computing device, etc. Where the shortcut program is downloaded from a server computer, the server computer from which the shortcut program is downloaded to the user's computing device may be the same or a different server computer from which the web page is downloaded to the user's computing device, for example. Alternatively, the shortcut program, or application, may already reside on the client's computing device, such as where the program was stored after being obtained from a server computing device or from another source, e.g., a computer readable medium. As yet another non-limiting example, the shortcut program may be a plug-in or other software component that is an add-on, and adds capability, to another application, such as a web browser. As a plug-in to a web browser application, the shortcut program may be used with a particular web page or web site as well as with different, multiple web pages and web sites; the user might use the shortcut program to navigate to different web pages and/or web sites, for example. The shortcut (program may be used to provide shortcuts for any type of content or resource, and the shortcuts provided by the program may be configured by the user.

At step 102, the shortcut program is initiated at the user's computing device. As discussed herein, the shortcut program may be initiated in connection with loading a webpage by a browser application executing on the user's computing device. At step 104, a listener component of the shortcut program may be loaded upon loading of a web page and initiation of the shortcut program, which listener, or listening, component listens for a triggering event, e.g., a double-click mouse input event, etc.

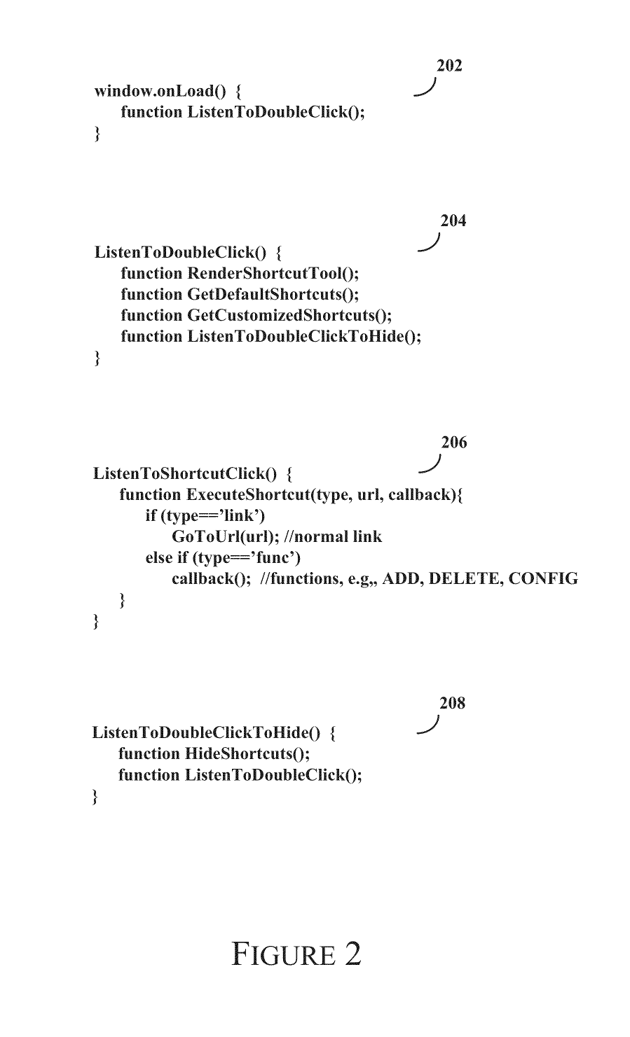

FIG. 2 provides pseudocode examples of a shortcut program in accordance with one or more embodiments of the present disclosure. Pseudocode example 202 includes a statement, window.onload, which causes a ListenToDoubleClick function to be loaded in connection with the downloading of the web page. As illustrated by pseudocode 204, the listener component may be implemented as part of the shortcut program, e.g., function ListenToDoubleClick. Additionally and as illustrated in FIG. 1, the shortcut program, e.g., the ListentoDoubleClick function, may include without limitation functions to render the shortcut GUI, e.g., RenderShortcutTool, obtain a set of default shortcuts, e.g., GetDefaultShortcuts, obtain a set of customized shortcuts, e.g., GetCusiomizedShortcuts, and a deactivation listener component to listen for a deactivation event, e.g., ListenToDoubleClickToHide.

Referring again to FIG. 1A, at step 106, a determination is made, e.g., by the ListenToDoubleClick function, whether or not a triggering event has occurred. If an occurrence of a triggering event is not detected, processing continues at step 104 to listen for a triggering event. Where occurrence of a triggering event is detected at step 106, such as where double click mouse user input is detected by the ListenToDoubleClick function, processing continues at step 108 to obtain the shortcuts and render the shortcut GUI, e.g., using the obtained shortcuts. At step 108, a determination is made whether to retrieve a set of default shortcuts, e.g., such as where there are no customized shortcuts for the user, or to retrieve a set of customized shortcuts, e.g., such as where the user has modified the set of shortcuts. By way of a non-limiting example, a customized set of shortcuts may comprise one or more shortcuts from a default set of shortcuts and one or more shortcuts specified by the user, or for the user. Where a determination is made to retrieve a set of default shortcuts is made, processing continues at step 112 to retrieve the default shortcuts. Where a determination is made that the user has customized shortcuts, processing continues at step 110 to retrieve the set of customized shortcuts.

In accordance with one or more embodiments, the information retrieved at step 110 or 112 may comprise mappings, each mapping of which maps a resource, e.g., the resource's identifier, e.g., URL, to a shortcut icon. A mapping may be a default mapping or a customized mapping. By way of a non-limiting example, the mappings may comprise default mappings, some or all of which may be replaced with a customized mapping. In accordance with one or more embodiments, the mappings may be stored locally, e.g., at the user's computing device, or remotely, e.g., at a server computing device. The mappings may be stored locally as a cookie or using any other data store, for example. Remotely-stored mappings may be retrieved by the shortcut program from the server computing device, and then stored in a cookie at the user's computing device, for example.

From step 110 or step 112, processing continues at step 114 of FIG. 1B to render the shortcut GUI, e.g., the shortcut GUI may be rendered in an application window, such as a browser application window. In accordance with one or more embodiments, the shortcut GUI may be rendered in an application window at a position, or location, on a display determined based on input received from the user, e.g., a user-specified location. By way of a non-limiting example, the shortcut GUI may be positioned in an application window, e.g., the browser's window in which the triggering event is detected. The position, or location, of the shortcut GUI may be relative to a location of the cursor at a time that the triggering event input is detected. By way of a further non-limiting example, the shortcut GUI may be positioned, e.g., the center of the shortcut GUI may be centered, at the location of the cursor at the time of the triggering event, or other location specified by the user or determined by the shortcut program/system. It should be apparent that any portion other than the center, of the shortcut GUI may be used to position the shortcut GUI relative to the location, e.g., the user-specified or system-specified location. Furthermore, the system-specified location may be a location determined based on explicit or implicit user input and/or preference.

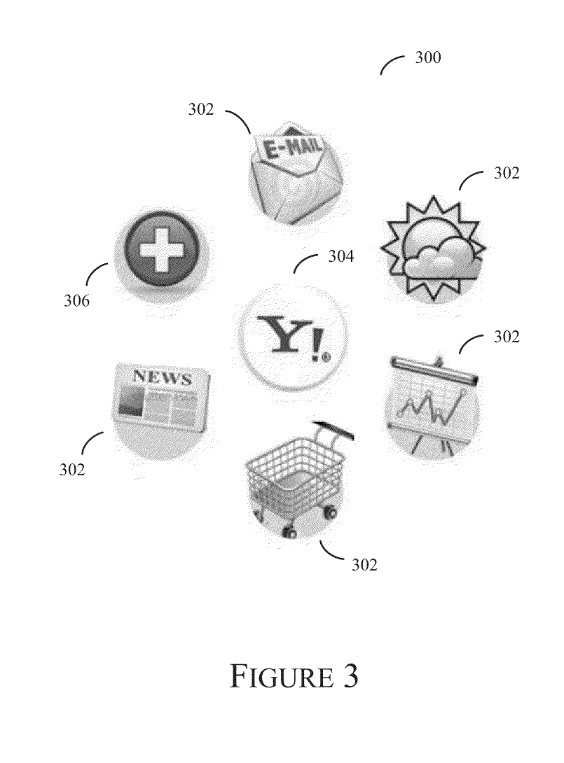

FIG. 3 provides an example of a shortcut GUI in accordance with one or more embodiments of the present disclosure. In the example of FIG. 3, shortcut GUI 300 comprises shortcut icons 302, each of which is mapped to a resource, which may be identified by a URL, and each icon may be selected, or is selectable, by the user to access the associated resource, e.g., to access and display a web page in the web browser window at the user's computing device. In the example, icons 302 provide shortcuts to electronic mail, weather, financial, shopping and news services.

Shortcut GUI 300 provides the user with an ability to configure the GUI. By way of an example, icon 306 provides the user with an ability to add one or more shortcuts to shortcut GUI 300. By way of a non-limiting example, the user may indicate a desire to add a shortcut by selecting icon 306. Although not shown, the shortcut GUI 300 may include other icons, or otherwise provide an ability to configure the shortcut GUI 300, including without limitation an ability to delete or edit/modify shortcuts provided by the shortcut GUI 300.

In accordance with one or more embodiments, the shortcut GUI 300 may be minimized, or folded, such as by clicking, single, double, etc. click, on icon 304. By way of a non-limiting example, in a minimized/folded state, or form, shortcut GUI may display only icon 304, and the user may be provided with the ability to select icon 304 in a minimized state to display shortcut GUI 300 in a maximized, or expanded, state. Additionally and in accordance with one or more embodiments, shortcut GUI 300 may be re-positioned by the user, e.g., using a drag and drop operation to select the shortcut GUI 300 and move it to another location. Other operations that may be used in connection with shortcut GUI 300 include without limitation re-sizing operations, which may increase or decrease the overall size of shortcut GUI 300 and/or increase or decrease the size of one or more of the icons in shortcut GUI.

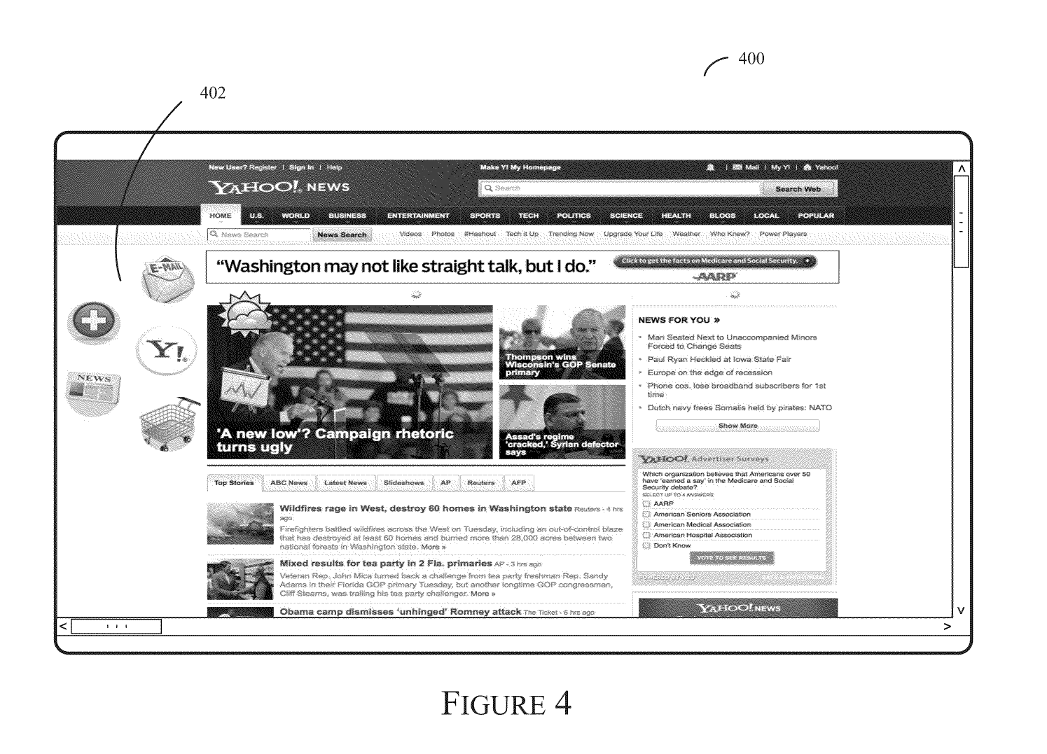

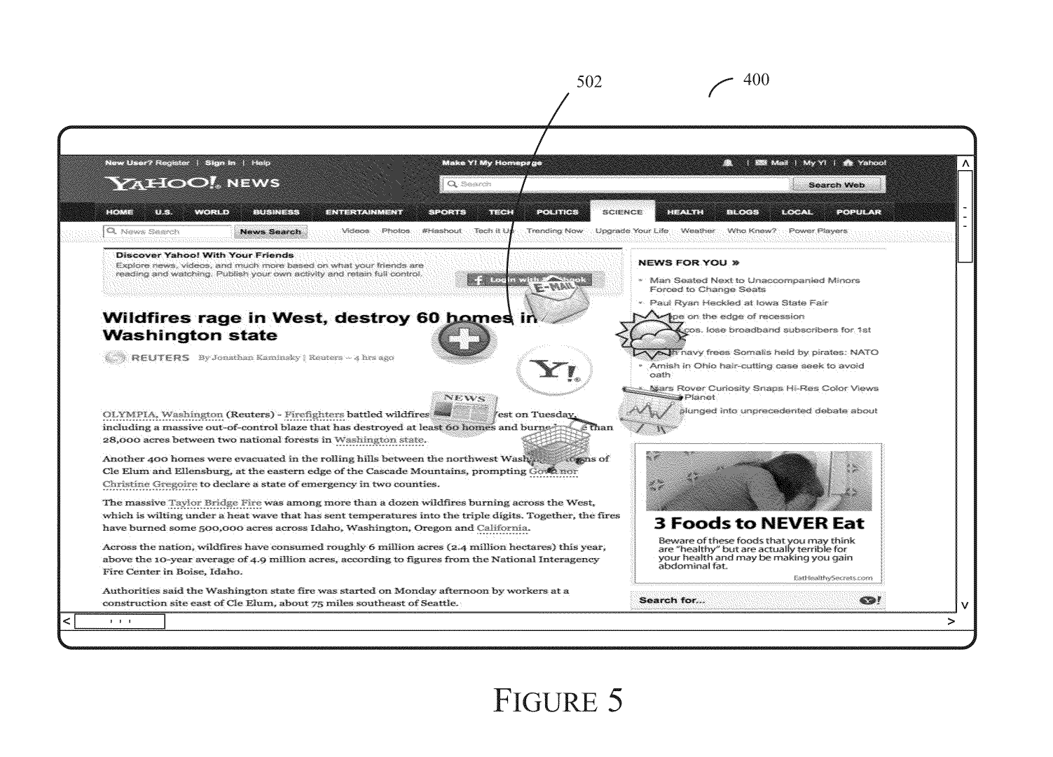

FIGS. 4 and 5 provide examples of shortcut GUI 300 rendered in an application window. In the examples, the shortcut GUI, shortcut GUI 402 displayed in window 400 in FIG. 4 and shortcut GUI 502 displayed in window 500 in FIG. 5, is rendered as a display layer in front of the contents of the application window, so that the shortcut GUI appears to be overlaid over, or superimposed on, the application window's contents. As can be seen from the examples shown in FIGS. 4 and 5, the location of shortcut GUI 300 need not be static, but rather may be dynamically determined, e.g., determined using positioning information received from the user and/or retrieved from a data store. Positioning information might be specified by the user using a pointing device, such as a mouse, for example. Since the user's attention is likely to be located at the specified position, e.g., a current cursor position or a position previously specified by, or known to, the user, the shortcut GUI 300 may be easily recognized, or located, by the user, so that the user may easily and readily access a resource.

Referring again to FIG. 1B, at steps 116 and 118, a listener component listens for an event occurrence in connection with displayed shortcut GUI 300, e.g., a mouse click event within a boundary associated with, e.g., a boundary that includes, the shortcut GUI 300. With reference to FIG. 2, pseudocode 206 provides an example of a function implementing a ListenToShortcutClick component. The pseudocode 206 provides examples of events that might be detected by the component. By way of one non-limiting example, an ExecuteShortCut function may be invoked in response to user selection of an icon 302 of GUI 300, which function causes a GoToUrl operation to cause the browser to access, in this case to go to, the link or URL associated with the selected icon 302. It should be apparent that any type of access is contemplated, including access to playback a media resource, for example.

By way of another non-limiting example, where an icon such as icon 304 or 306, is selected by the user, ListenToShortcutClick responds to the user input and provides the user with an ability to perform the requested function, e.g., add, delete, configure, etc. functions.

Pseudocode 208 provides an example of another listener component, which listens for user input indicating a desire to hide the shortcut GUI 300. The ListenToDoubleClickToHide function listens for a mouse event, e.g., a double click event, and in response causes the shortcut GUI 300 to be hidden from the display and alerts the ListenToDoubleClick function to listen for an event triggering display of the shortcut GUI 300.

Referring again to FIG. 1B, where the shortcut GUI 300 is rendered at step 114, processing continues at steps 116 and 118 to listen for an event associated with shortcut GUI 300, as discussed above. Where an event is detected, processing continues at step 120 of FIG. 1C to make a determination of an event type. At step 120, a determination is whether the event type is a hide shortcut event. If so, processing continues at step 122, and shortcut GUI 300 is hidden from display, and processing continues at step 104 of FIG. 1A. If not, processing continues at step 124, where a determination is made whether or not the event type is a URL shortcut selection event. If so, processing continues at step 126 to access the resource indicated by the selected shortcut, and processing continues at step 116 of FIG. 19. If not, processing continues at step 126, where a determination is made whether or not the event type is a function event, such as a function to add a shortcut, delete a shortcut, etc. If so, processing continues at step 130 to perform the requested function, and processing continues at step 116 of FIG. 113, if not, processing continues at step 116 of FIG. 1B.

As discussed herein, in accordance with one or more embodiments, the shortcut program may be written in a scripting language, such as JavaScript. At least some portion of the shortcut program may be written using a markup language, such as a hypertext markup language (HTML). By way of a non-limiting example, HTML has an onDblclick event mechanism, which may be used to render the shortcut GUI 300.

As discussed herein, in accordance with one or more embodiments, a listener component, e.g. a double-click listener that listens for a double-click event, triggers the rendering/display of shortcut GUI 300. The shortcut program might listen for any click input and make a determination whether or not the click input is intended for use by the shortcut program or by the application, e.g., the browser. For example, the shortcut program might listen for a first click and wait a specific time period, e.g., 100 milliseconds (MS), for another click; and, if a second click is detected within the specified time, the shortcut program interprets the click input to be for the shortcut program, and if a second click is not detected within the specified time, the shortcut program may pass the click input to the underlying application, e.g., a browser application, for processing.

In accordance with one or more embodiments, the shortcut program may retrieve a default set of shortcuts and/or a customized set of shortcuts from a server computer by sending an XHR request to the server computer. By way of a non-limiting example, the shortcut program may send one or more XMLHttpRequests, or XHRs, to one or more server computers to retrieve a user's shortcut data in response to a triggering event. As discussed herein, the shortcut data may comprise information that maps a resource, e.g., a resource's URL or other identifier, to an icon in the shortcut GUI 300. The shortcut data may include other information, including without limitation user identification information, cursor and/or GUI positioning information, etc. Alternatively or in addition to storing shortcut data by one or more server computing devices, embodiments of the present disclosure contemplate use of local storage, e.g., storage at the user's computing device, such as without limitation cookies/H5 storage, to store shortcut data. By way of a non-limiting example, a local data store may be used to store shortcut mapping information and/or shortcut GUI positioning information, e.g., cursor position. A cookie or H5 storage may be a file or other data storage object that might be used to save data, such as shortcut data used in accordance with one or more embodiments of the present disclosure. The data file may be stored, e.g., in memory or other computer-readable medium, at the user's computing device, at a server computing device, or both. The data file may be transmitted to the user's computing device via at least one server computing device and at least one network.

In accordance with one or more embodiments, the shortcut program may request the underlying application program, e.g., a browser application, to render the shortcut GUI 300 such as in an application window. The shortcut program might request the browser application to render the shortcut GUI 300 on top of the contents being displayed in the application window, e.g., on top of the web page currently being displayed by the browser application. Positioning of the shortcut GUI 300 may be with reference to the location, e.g. an XY position in a case of a two-dimensional space, saved by the shortcut program or a current XY position, in a case of a two-dimensional space, of the cursor.

One or more aspects of the shortcut GUI 300 may be animated, e.g., using cascading style sheet (CSS) transition effects. For example, a CSS property may be identified to be animated from a base value to a final value in response to a triggering event, e.g., a hover event where the cursor is positioned over an icon.

In accordance with one or more embodiments, as described herein, a shortcut icon may correspond to a link or URL. Alternatively, the shortcut icon may correspond to a function. One such function may be an add function, where the user is given an opportunity to add a shortcut to shortcut GUI 300. For example, when the user clicks on icon 306 in FIG. 3, the shortcut program may identify a UPI, e.g., the current URL of the web page displayed by the browser application or a portion of the URL such as the domain portion, and cause mapping information to be stored for the identified URL. To further illustrate, the shortcut program may send information, e.g., user identification information, URL information, shortcut or icon information, etc., by XHR request to a server computer, and/or save such information locally in one or more shortcut data files, such as a one or more cookies or HR data stores. The URL identified for use as a shortcut may be derived from another URL, e.g., extracted from another URL by parsing the URL to identify the desired portion. By way of a non-limiting example, the desired portion may be a domain of the resource. Parsing may be performed by the shortcut program at the user's computing device or by a server computing device to identify a portion of the URL to be associated with a shortcut. Once an icon is added as a shortcut, the shortcut program may request that the underlying application redraw the shortcut GUI 300 to display the icon for the newly-added shortcut in shortcut GUI 300. Optionally, a server computer may transmit some data that may be used by the underlying application, e.g., the browser application, to render the shortcut GUI 300 updated to include the newly-added shortcut and corresponding icon. Conversely, where shortcut is deleted, the shortcut GUI 300 is re-rendered to remove, or hide, the icon corresponding to the deleted shortcut. By way of a non-limiting example, the user might remove a shortcut by selecting its icon in shortcut GUI 300 and dragging and dropping the icon outside a boundary of the shortcut GUI 300. As discussed in connection with an add operation, information may be transmitted to one or more server computers to update the user's shortcut data, and/or a server computer may transmit data to the user's computing device for use in re-rendering shortcut GUI 300.

In accordance with one or more embodiments, display of shortcut GUI 300 may be triggered by the user clicking anywhere in an application window or other area of a display. The user may minimize, or fold, shortcut GUI 300, e.g., a minimized shortcut GUI 300 may include icon 304, by clicking somewhere on or near the center of shortcut GUI 300, such as via a clicking on, or selecting, icon 304. Conversely, the user may expand shortcut GUI 300 by clicking on or near the minimize shortcut GUI 300.

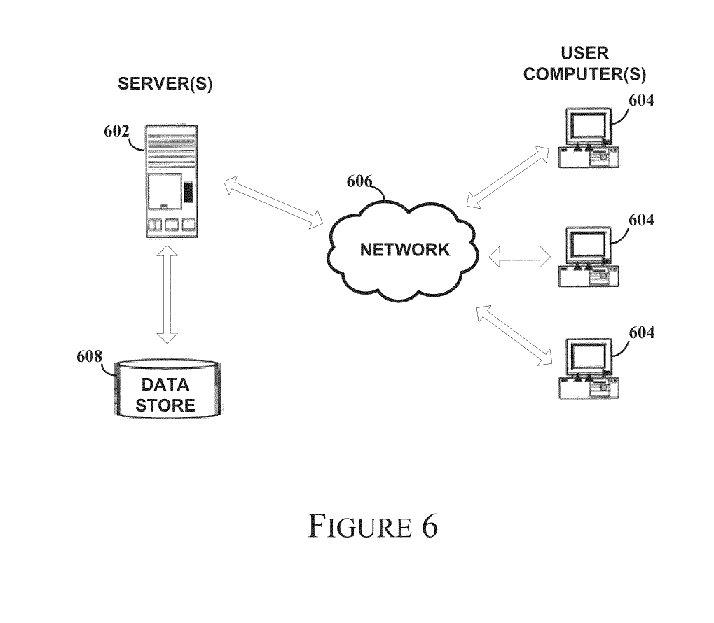

FIG. 6 illustrates some components that can be used in connection with one or more embodiments of the present disclosure. In accordance with one or more embodiments of the present disclosure, one or more computing devices, e.g., one or more server computer or computing devices, user computing devices or other computing device, are configured to comprise functionality described herein. For example, a computing device 602 can be configured to execute program code, instructions, etc. to provide functionality in accordance with one or more embodiments of the present disclosure. By way of a non-limiting example, one or more of computing device 602 can be configured to transmit a shortcut program, or system, and/or shortcut data in accordance with one or more embodiments.

Computing device 602 can serve content to user computing devices 604 using a browser application via a network 606. Data store 608 may be used to store program code of a shortcut program and/or shortcut data, as well as program code to configure a server 602.

The user computing device 604 can be any computing device, including without limitation a personal computer, personal digital assistant (PDA), wireless device, cell phone, internet appliance, media player, home theater system, and media center, or the like. For the purposes of this disclosure a computing device includes a processor and memory for storing and executing program code, data and software, and may be provided with an operating system that allows the execution of software applications in order to manipulate data. A computing device such as server 602 and the user computing device 604 can include one or more processors, memory, a removable media reader, network interface, display and interface, and one or more input devices, e.g., keyboard, keypad, mouse, etc. and input device interface, for example. One skilled in the art will recognize that server 602 and user computing device 604 may be configured in many different ways and implemented using many different combinations of hardware, software, or firmware. Computing device 60.4 may be a device that executes a shortcut program in accordance with one or more embodiments of the present disclosure.

In accordance with one or more embodiments, a computing device 602 can make a user interface available to a user computing device 604 via the network 606. The user interface made available to the user computing device 604 can include content items, or identifiers (e.g., URLs) selected for the user interface in accordance with one or more embodiments of the present invention. In accordance with one or more embodiments, computing device 602 makes a user interface available to a user computing device 604 by communicating a definition of the user interface to the user computing device 604 via the network 606. The user interface definition can be specified using any of a number of languages, including without limitation a markup language such as Hypertext Markup Language, scripts, applets and the like. The user interface definition can be processed by an application executing on the user computing device 604, such as a browser application, to output the user interface on a display coupled, e.g., a display directly or indirectly connected, to the user computing device 604.

In an embodiment the network 606 may be the Internet, an intranet (a private version of the Internet), or any other type of network. An intranet is a computer network allowing data transfer between computing devices on the network. Such a network may comprise personal computers, mainframes, servers, network-enabled hard drives, and any other computing device capable of connecting to other computing devices via an intranet. An intranet uses the same Internet protocol suit as the Internet. Two of the most important elements in the suit are the transmission control protocol (TCP) and the Internet protocol (IP).

As discussed, a network may couple devices so that communications may be exchanged, such as between a server computing device and a client computing device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, or any combination thereof. Likewise, sub-networks, such as may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs. A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a telephone line or link, for example.

A wireless network may couple client devices with a network. A wireless network may employ stand-alone ad-hoc networks, mesh networks, Wireless LAN (WLAN) networks, cellular networks, or the like. A wireless network may further include a system of terminals, gateways, routers, or the like coupled by wireless radio links, or the like, which may move freely, randomly or organize themselves arbitrarily, such that network topology may change, at times even rapidly. A wireless network may further employ a plurality of network access technologies, including Long Term Evolution (LTE), WEAN, Wireless Router (WR) mesh, or 2nd, 3rd, or 4th generation (2G, 3G, or 4G) cellular technology, or the like. Network access technologies may enable wide area coverage for devices, such as client devices with varying degrees of mobility, for example. For example, a network may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like. A wireless network may include virtually any type of wireless communication mechanism by which signals may be communicated between devices, such as a client device or a computing device, between or within a network, or the like.

Signal packets communicated via a network, such as a network of participating digital communication networks, may be compatible with or compliant with one or more protocols. Signaling formats or protocols employed may include, for example, TCP/IP, UDP, DECnet, NetBEIJI, IPX, Appletalk, or the like. Versions of the Internet Protocol (IP) may include IPv4 or IPv6. The Internet refers to a decentralized global network of networks. The Internet includes local area networks (LANs), wide area networks (WANs), wireless networks, or long haul public networks that, for example, allow signal packets to be communicated between LANs. Signal packets may be communicated between nodes of a network, such as, for example, to one or more sites employing a local network address. A signal packet may, for example, be communicated over the Internet from a user site via an access node coupled to the Internet. Likewise, a signal packet may be forwarded via network nodes to a target site coupled to the network via a network access node, for example. A signal packet communicated via the Internet may, for example, be routed via a path of gateways, servers, etc. that may route the signal packet in accordance with a target address and availability of a network path to the target address.

It should be apparent that embodiments of the present disclosure can be implemented in a client-server environment such as that shown in FIG. 8. Alternatively, embodiments of the present disclosure can be implemented with other environments. As one non-limiting example, a peer-to-peer (or P2P) network may employ computing power or bandwidth of network participants in contrast with a network that may employ dedicated devices, such as dedicated servers, for example; however, some networks may employ both as well as other approaches. A P2P network may typically be used for coupling nodes via an ad hoc arrangement or configuration. A peer-to-peer network may employ some nodes capable of operating as both a “client” and a “server.”

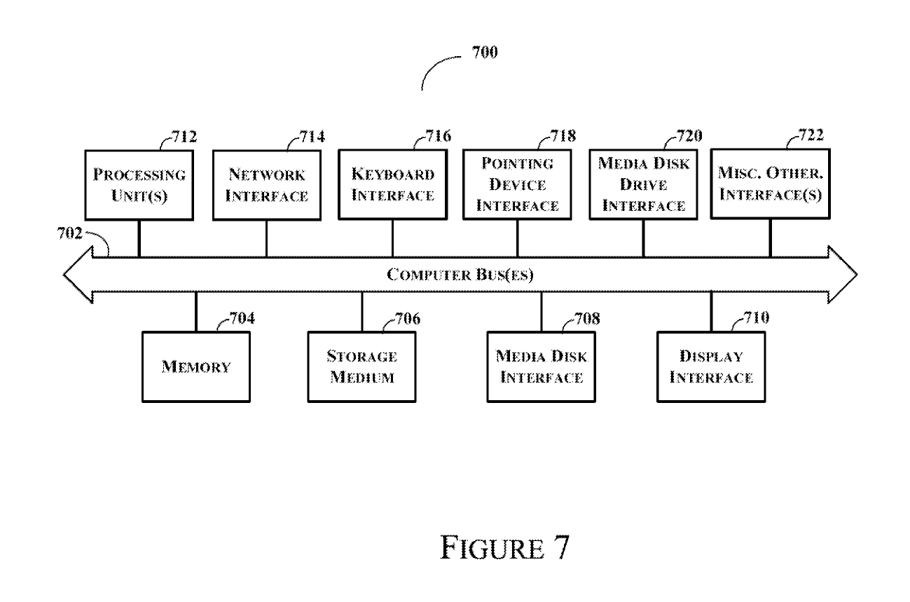

FIG. 7 is a detailed block diagram illustrating an internal architecture of a computing device, e.g., a computing device such as server 602 or user computing device 604, in accordance with one or more embodiments of the present disclosure. As shown in FIG. 7, internal architecture 700 includes one or more processing units, processors, or processing cores, (also referred to herein as CPUs) 712, which interface with at least one computer bus 702. Also interfacing with computer bus 702 are computer-readable medium, or media, 706, network interface 714, memory 704, e.g., random access Memory (RAM), run-time transient memory, read only memory (ROM), etc., media disk drive interface 720 as an interface for a drive that can read and/or write to media including removable media such as floppy, CD-ROM, MD, etc. media, display interface 710 as interface for a monitor or other display device, keyboard interface 716 as interface for a keyboard, pointing device interface 718 as an interface for a mouse or other pointing device, and miscellaneous other interfaces not shown individually, such as parallel and serial port interfaces, a universal serial bus (USB) interface, and the like.

Memory 704 interfaces with computer bus 702 so as to provide information stored in memory 704 to CPU 712 during execution of software programs such as an operating system, application programs, device drivers, and software modules that comprise program code, and/or computer-executable process steps, incorporating functionality described herein, e.g., one or more of process flows described herein. CPU 712 first loads computer-executable process steps from storage, e.g., memory 704, computer-readable storage medium/media 706, removable media drive, and/or other storage device. CPU 712 can then execute the stored process steps in order to execute the loaded computer-executable process steps. Stored data, e.g., data stored by a storage device, can be accessed by CPU 712 during the execution of computer-executable process steps.

Persistent storage, e.g., medium/media 706, can be used to store an operating system and one or more application programs. Persistent storage can also be used to store device drivers, such as one or more of a digital camera driver, monitor driver, printer driver, scanner driver, or other device drivers, web pages, content files, playlists and other files. Persistent storage can further include program modules and data files used to implement one or more embodiments of the present disclosure, e.g., listing selection module(s), targeting information collection module(s), and listing notification module(s), the functionality and use of which in the implementation of the present disclosure are discussed in detail herein.

For the purposes of this disclosure a computer readable medium stores computer data, which data can include computer program code that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client or server or both. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client or server or both. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

While the system and method have been described in terms of one or more embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A method comprising:
receiving a triggering event by at least one computing device, the event having location information identifying a display location;
retrieving, by the at least one computing device in response to the triggering event, shortcut information comprising a set of shortcut mappings, each shortcut mapping associating a selectable indicium in a shortcut graphical user interface (GUI) and a resource identifier;
causing, by the at least one computing device, the shortcut GUI to be displayed superimposed on an application display window for the user at the display location;
in response to receiving input indicative of the user selection of the selectable indicium in the shortcut GUI, the at least one computing device accessing the resource for the user using the resource identifier.

2. The method of claim 1, wherein the triggering event is received via an end user application executing at the user's computing device.

3. The method of claim 2, wherein the display location is a location within a display window of the end user application.

4. The method of claim 3, wherein the end user application is a browser application, the resource identifier is a universal resource locator and the resource is a web page, accessing the resource for the user further comprising:
the at least one computing device causing the web page to be displayed in the display window of the browser application.

5. The method of claim 2, the causing the shortcut GUI to be displayed further comprising:
the shortcut program instructing the end user application to display the shortcut GUI at the display location.

6. The method of claim 1, wherein the triggering event comprises input received from a pointing device and the display location is a location indicated via the pointing device.

7. The method of claim 1, wherein the display location is determined from stored location information.

8. The method of claim 7, wherein the stored location information is a location previously indicated by the user.

9. The method of claim 1, the shortcut GUI further comprising at least one indicium selectable to configure the shortcut GUI.

10. The method of claim 9, the at least one indicium is selectable to perform an add operation to add a new shortcut mapping.

11. The method of claim 9, the at least one indicium is selectable to perform a modify operation to modify an existing shortcut mapping.

12. The method of claim 9, the at least one indicium is selectable to perform a delete operation to delete an existing shortcut mapping.

13. The method of claim 1, the method further comprising:
in response to a triggering event, displaying a minimized form of the shortcut GUI.

14. The method of claim 1, the method further comprising:
in response to a triggering event, displaying a maximized form of the shortcut GUI.

15. The method of claim 1, the method further comprising:
in response to a triggering event, repositioning the shortcut GUI to another display location.

16. A system comprising:
at least one computing device comprising one or more processors to execute and memory to store instructions to:
receive a triggering event, the event having location information identifying a display location;
retrieve, in response to the triggering event, shortcut information comprising a set of shortcut mappings, each shortcut mapping associating a selectable indicium in a shortcut graphical user interface (GUI) and a resource identifier;
cause the shortcut GUI to be displayed superimposed on an application display window for the user at the display location;
in response to receiving input indicative of the user selection of the selectable indicium in the shortcut GUI, access the resource for the user using the resource identifier.

17. The system of claim 16, wherein the triggering event is received via an end user application executing at the user's computing device.

18. The system of claim 17, wherein the display location is a location within a display window of the end user application.

19. The system of claim 18, wherein the end user application is a browser application, the resource identifier is a universal resource locator and the resource is a web page, instructions to access the resource for the user further comprising instructions to: cause the web page to be displayed in the display window of the browser application.

20. The system of claim 17, the instructions to cause the shortcut GUI to be displayed further comprising instructions to:
instruct the end user application to display the shortcut GUI at the display location.

21. The system of claim 16, wherein the triggering event comprises input received from a pointing device and the display location is a location indicated via the pointing device.

22. The system of claim 16, wherein the display location is determined from stored location information.

23. The system of claim 22, wherein the stored location information is a location previously indicated by the user.

24. The system of claim 16, the shortcut GUI further comprising at least one indicium selectable to configure the shortcut GUI.

25. The system of claim 24, the at least one indicium is selectable to perform an add operation to add a new shortcut mapping.

26. The system of claim 24, the at least one indicium is selectable to perform a modify operation to modify an existing shortcut mapping.

27. The system of claim 24, the at least one indicium is selectable to perform a delete operation to delete an existing shortcut mapping.

28. The system of claim 16, the instructions further comprising instructions to:
in response to a triggering event, display a minimized form of the shortcut GUI.

29. The system of claim 16, the instructions further comprising instructions to:
in response to a triggering event, display a maximized form of the shortcut GUI.

30. The system of claim 16, the instructions further comprising instructions to:
in response to a triggering event, reposition the shortcut GUI to another display location.

31. A computer readable non-transitory storage medium for tangibly storing thereon computer readable instructions that when executed cause at least one processor to:
receive a triggering event, the event having location information identifying a display location;
retrieve, in response to the triggering event, shortcut information comprising a set of shortcut mappings, each shortcut mapping associating a selectable indicium in a shortcut graphical user interface (GUI) and a resource identifier;
cause the shortcut GUI to be displayed superimposed on an application display window for the user at the display location;
in response to receiving input indicative of the user selection of the selectable indicium in the shortcut GUI, access the resource for the user using the resource identifier.

32. The medium of claim 31, wherein the triggering event is received via an end user application executing at the user's computing device.

33. The medium of claim 32, wherein the display location is a location within a display window of the end user application.

34. The medium of claim 33, wherein the end user application is a browser application, the resource identifier is a universal resource locator and the resource is a web page, instructions to access the resource for the user further comprising instructions to: cause the web page to be displayed in the display window of the browser application.

35. The medium of claim 32, the instructions to cause the shortcut GUI to be displayed further comprising instructions to:
instruct the end user application to display the shortcut GUI at the display location.

36. The medium of claim 31, wherein the triggering event comprises input received from a pointing device and the display location is a location indicated via the pointing device.

37. The medium of claim 31, wherein the display location is determined from stored location information.

38. The medium of claim 37, wherein the stored location information is a location previously indicated by the user.

39. The medium of claim 31, the shortcut GUI further comprising at least one indicium selectable to configure the shortcut GUI.

40. The medium of claim 39, the at least one indicium is selectable to perform an add operation to add a new shortcut mapping.

41. The medium of claim 39, the at least one indicium is selectable to perform a modify operation to modify an existing shortcut mapping.

42. The medium of claim 39, the at least one indicium is selectable to perform a delete operation to delete an existing shortcut mapping.

43. The medium of claim 31, the instructions further comprising instructions to:
in response to a triggering event, display a minimized form of the shortcut GUI.

44. The medium of claim 31, the instructions further comprising instructions to:
in response to a triggering event, display a maximized form of the shortcut GUI.

45. The medium of claim 31, the instructions further comprising instructions to:
in response to a triggering event, reposition the shortcut GUI to another display location.
